(19) United States
(12) Patent Application Publication
(10) Pub. No.: US 2026/0277686 A1
(43) Pub. Date: Sep. 17, 2026

(54) SYSTEM FOR UNIFIED ENTITLEMENT CALCULATION OF CROSS-PLATFORM DISTRIBUTED RESOURCES

(71) Applicant: C8QUANT LLC, Sheridan, WY (US)

(72) Inventors: Qibiao NIE, Dalian (CN); Yuqi WANG, Dalian (CN); Xing YE, Dalian (CN)

(21) Appl. No.: 19/673,263

(22) Filed: May 11, 2026

(51) Int. Cl. G06F 9/50

(52) U.S. Cl. CPC G06F 9/5027

(57) ABSTRACT

A system for unified entitlement calculation of cross-platform distributed resources establishes binding relationships between multiple users and resource accounts on multiple resource exchange platforms, thereby breaking limitations of entitlement accounting confined to a single platform and a single account and adapting to cross-platform distributed resource transaction scenarios. By creating an internal resource record carrier, the system realizes standardized and unified measurement of different resource types. Based on a unified strategy, the system generates and executes resource allocation instructions, without performing any actual resource transfer between resource accounts. The system further performs separate and precise calculation of actual resource holding variation and rule-determined resource variation of each user. By adjusting the internal resource record carrier based on a difference between the actual resource holding variation and the rule-determined resource variation of each user, without modifying actual resource holding amounts of the resource accounts, the system achieves precise balancing of entitlements.

### TECHNICAL FIELD

This application relates to the technical field of computer-implemented distributed account management, and more particularly, to a system for unified entitlement calculation of cross-platform distributed resources.

### BACKGROUND

With the development of the field of distributed resource transactions, scenarios involving resource allocation and entitlement accounting across multiple resource exchange platforms have become increasingly complex. Multiple users may each open at least one resource account on different resource exchange platforms to perform resource operations, and different resource accounts may involve diverse resource types having differing measurement schemes. In the prior art, however, users’ resources are required to be centrally custodized before unified entitlement settlement can be performed, or entitlement calculation can only be carried out independently for a single resource account or a single resource exchange platform. In some cases, manual intervention or post-hoc reconciliation is further required to correct resource entitlement results. Such approaches not only fail to accommodate real-time resource allocation scenarios involving multiple users, multiple resource exchange platforms, and multiple resource types, because the resource exchange platforms are required to have control over resource custody or resource inflow and outflow, but also lack an automated and verifiable capability for cross-platform unified entitlement calculation of resources. Accordingly, these approaches are unable to meet the entitlement accounting requirements of current cross-platform distributed resource transactions.

### SUMMARY

The present disclosure provides a system for unified entitlement calculation of cross-platform distributed resources. The system enables adjustment of an entitlement value of a resource account, as recorded in an internal resource record carrier, without modifying an actual resource holding amount of the resource account, thereby achieving precise balancing of resource entitlements. The system further realizes automated, standardized, and decoupled unified calculation of entitlements for cross-platform distributed resources, and significantly improves the efficiency and accuracy of cross-platform resource entitlement accounting.

In a first aspect, the present disclosure provides a system for unified entitlement calculation of cross-platform distributed resources. The system includes one or more processors, and one or more memories storing computer-executable instructions which, when executed by the one or more processors, cause the system to:

establish at least one relationship between each user of a plurality of users and at least one resource account on a plurality of resource exchange platforms, and record resource information of each resource account of the at least one resource account, each of the at least one resource account having a different resource type from one another;

create, for each user, an internal resource record carrier configured to store an entitlement value associated with the user expressed in a common virtual metering unit;

generate, based on a unified strategy, a plurality of resource allocation instructions for resource accounts of all of the plurality of users, to control each of the resource accounts of all of the plurality of users to independently execute the corresponding resource allocation instruction, without performing any actual resource transfer between the resource accounts of all of the plurality of users;

after execution of the plurality of resource allocation instructions, calculate an actual resource holding variation of the at least one resource account of each user, and calculate a rule-determined resource variation of the at least one resource account of each user according to a predetermined rule; and

adjust, based on a difference between the rule-determined resource variation and the actual resource holding variation, the entitlement value of each user stored in the internal resource record carrier, without modifying an actual resource holding amount of each resource account of each user.

In a second aspect, the present disclosure provides a non-transitory computer-readable storage medium storing computer-executable instructions which, when executed by one or more processors, cause the one or more processors to perform operations of the system provided in the first aspect.

As can be seen from the above technical solutions, the system is configured to establish the at least one relationship between each user of the plurality of users and the at least one resource account on the plurality of resource exchange platforms and to record resource information of each resource account of the at least one resource account, where each of the at least one resource account has a different resource type from one another, thereby achieving association and adaptation among multiple users, multiple resource exchange platforms, and multiple resource accounts, overcoming limitations of resource entitlement accounting confined to a single platform or a single account, and adapting to distributed resource transaction scenarios involving multiple entities across platforms. The system is further configured to create, for each user, the internal resource record carrier configured to store the entitlement value associated with the user expressed in the common virtual metering unit, thereby achieving standardized and unified measurement of different resource types, solving problems of entitlement accounting caused by inconsistent measurement schemes among different resource types, and enabling more consistent and accurate cross-type resource entitlement calculation. The system is further configured to generate, based on the unified strategy, the plurality of resource allocation instructions for the resource accounts of all of the plurality of users, to control each of the resource accounts of all of the plurality of users to independently execute the corresponding resource allocation instruction, without performing any actual resource transfer between the resource accounts of all of the plurality of users, thereby achieving strategy consistency for cross-platform resource allocation, avoiding risks associated with actual resource transfer between resource accounts, and ensuring independence of resources in each resource account. The system is further configured to, after execution of the plurality of resource allocation instructions, calculate the actual resource holding variation of the at least one resource account of each user, and calculate the rule-determined resource variation of the at least one resource account of each user according to the predetermined rule, thereby achieving separate and precise accounting of actual resource changes and entitled resource benefits, and providing a clear quantitative basis for entitlement allocation. The system is further configured to adjust, based on the difference between the rule-determined resource variation and the actual resource holding variation, the entitlement value of each user stored in the internal resource record carrier, without modifying the actual resource holding amount of each resource account of each user, thereby achieving precise balancing of resource entitlements. The system of the present disclosure compensates for differences between entitled resource benefits and actual resource benefits of users by adjusting the internal resource record carrier, without modifying actual resource states of resource accounts on the resource exchange platforms, thereby enabling fair and reasonable unified accounting and balancing of user resource entitlements in cross-platform distributed resource transactions. Accordingly, automated, standardized, and independent unified calculation of entitlements for cross-platform distributed resources is achieved, significantly improving efficiency and accuracy of cross-platform resource entitlement accounting.

Further effects of preferred embodiments will be described in detail below with reference to specific examples.

### BRIEF DESCRIPTION OF THE DRAWINGS

To describe technical solutions in embodiments of the present disclosure or the prior art more clearly, the following briefly introduces the accompanying drawings required for describing the embodiments of the present disclosure or the prior art. Apparently, the accompanying drawings in the following description merely illustrate some embodiments of the present disclosure. Those of ordinary skill in the art may also obtain other accompanying drawings based on these provided herein without creative efforts.

FIG. 1 is a schematic diagram of a system for unified entitlement calculation of cross-platform distributed resources according to embodiments of the present disclosure.

FIG. 2 is a schematic structural diagram of an electronic device according to embodiments of the present disclosure.

FIG. 3 is a schematic diagram of a system of the present disclosure according to embodiments of the present disclosure.

### DETAILED DESCRIPTION OF EMBODIMENTS

In order to make the objectives, technical solutions, and advantages of the present disclosure clearer, the technical solutions of the present disclosure will be described clearly and completely below with reference to specific embodiments and the accompanying drawings. It may be understood that the described embodiments are only some embodiments of the present disclosure, rather than all embodiments. All other embodiments obtained by those of ordinary skill in the art based on the embodiments of the present disclosure without inventive effort shall fall within the scope of protection of the present disclosure.

Various non-limiting embodiments of the present disclosure will be described in detail below with reference to the accompanying drawings.

The present disclosure relates to the technical field of computer-implemented distributed resource management, and in particular to a system and a method for unified entitlement calculation of cross-platform distributed resources. The present disclosure is applicable to cross-platform resource transaction scenarios involving multiple users, multiple resource exchange platforms, multiple resource accounts, and multiple resource types, and is particularly suitable for distributed account unified entitlement calculation and balancing in quantitative trading scenarios of crypto assets.

Terms and specialized expressions used in the specification are defined as follows, and are used consistently throughout the specification.

Resource exchange platform: refers to a resource exchange platform, i.e., a network platform that provides resource trading, custody, and query services, including crypto asset exchanges and digital asset trading platforms, such as Coinbase, bitFlyer, and Upbit.

Resource account: refers to an exchange account, i.e., an account opened by a user on a resource exchange platform for holding and trading resources, and capable of supporting valuation in different resource types.

Resource type: refers to a denomination unit, including crypto assets and fiat currency resources such as stablecoins (e.g., USDT, USDC) and fiat currencies (e.g., USD, JPY, KRW).

Internal resource record carrier: refers to an internal entitlement account, i.e., an internal dedicated accounting carrier created by the system for each user to uniformly measure entitlements of different resource types, and measured using a common virtual metering unit (e.g., database account records, internal entitlement units, virtual points, or digital certificates).

Common virtual metering unit: refers to an internal entitlement unit, i.e., a unified accounting unit defined within the system for converting resource information of different resource types into a unified unit for entitlement calculation, and capable of being equivalently linked to one or more preset reference resource types.

Resource allocation instruction: refers to a trading instruction, i.e., a structured instruction generated by the system based on a unified strategy for controlling a resource account to perform resource transaction operations.

Unified strategy: refers to a unified quantitative trading strategy, i.e., a programmable cross-platform resource allocation optimization strategy employed by the system.

Actual resource holding variation: refers to actual asset variation or actual account profit/loss variation, i.e., a variation value of resource holdings after execution of resource allocation instructions by a resource account, including changes in asset quantity, valuation balance, and realized profit or loss.

Platform-wide cumulative resource result: refers to a total transaction result or total profit of all of the multiple resource exchange platforms, i.e., a total variation value obtained by aggregating actual resource holding variations of all resource accounts on all of the multiple resource exchange platforms and converting the aggregated value into the common virtual metering unit.

Resource transfer: refers to fund transfer or asset transfer, i.e., operations involving actual transfer, withdrawal, or custody of resources between resource accounts.

In this specification, application programming interface is abbreviated as API, and hypertext transfer protocol is abbreviated as HTTP. The above abbreviations are used consistently throughout the specification without repeated indication of full names.

The system for unified entitlement calculation of cross-platform distributed resources of the present disclosure (hereinafter referred to as “the system”) is a non-custodial distributed computing system that only obtains API query permission and resource allocation execution permission of resource accounts, without obtaining resource withdrawal, custody, or resource transfer permissions, and does not interfere with actual resource holding states of users on resource exchange platforms.

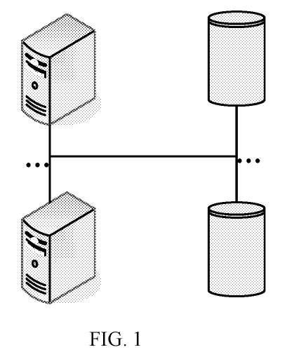

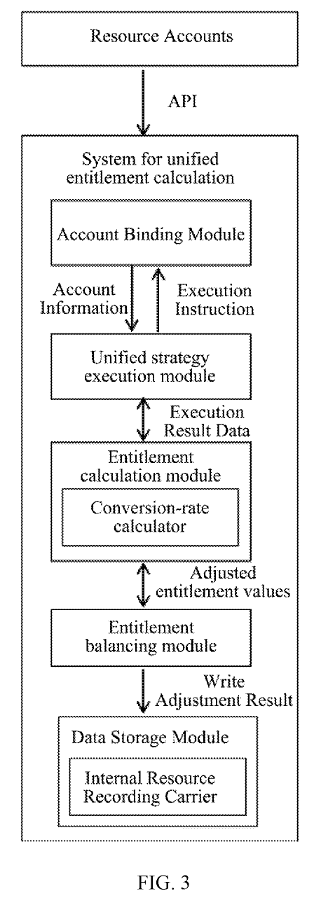

As shown in FIGS. 1 and FIG. 3, at a hardware level, the system includes one or more processors and one or more memories storing computer-executable instructions, which, when executed by the one or more processors, cause the system to implement unified entitlement calculation of cross-platform distributed resources. At a software level, the system adopts a modular architecture, including system modules such as an account binding module (corresponding to resource account binding), a unified strategy execution module (corresponding to generation and execution of resource allocation instructions), an entitlement calculation module (corresponding to calculation of actual resource holding amount and rule-determined resource variation), and an entitlement balancing module (corresponding to adjustment of internal resource record carriers). The system further includes an anomaly monitoring module, a data storage module, and a user interaction module. These modules operate cooperatively to implement a fully automated workflow from resource account binding to entitlement balancing and data presentation.

The internal resource record carrier is a computer-implemented data structure in the present system. In some embodiments, the internal resource record carrier may be understood as a points account. From the perspective of system implementation, a processor is configured to execute program logic to create, update, and compute the internal resource record carrier, and a memory is configured to store data content of the internal resource record carrier. At the system architecture level, the internal resource record carrier forms part of an entitlement calculation module and is configured to interact with other modules.

A core execution logic of the system is as follows: establishing a relationship between users and resource accounts and recording resource information → creating internal resource record carriers to achieve unified measurement → generating and executing resource allocation instructions → calculating actual resource holding variations and rule-determined resource variations → adjusting internal resource record carriers based on differences → completing data storage and presentation. The entire process is performed without manual intervention, and each resource account independently executes operations without any actual resource transfer.

### Detailed Execution Operations and Implementation Details

Step I: Establishing the at least one relationship between each user of a plurality of users and the at least one resource account on a plurality of resource exchange platforms, and recording resource information of each resource account.

It may be noted that a plurality of resource accounts collectively form a unified resource calculation pool within the system. Step I corresponds to an initialization binding stage of the system and is executed by the account binding module of the system. Step I includes the following two sub-steps: (i) resource account mapping and resource information recording; and (ii) system permission acquisition and restriction. Upon completion of the initialization binding stage, the system further obtains corresponding permissions and performs permission restriction.

### Resource account mapping and resource information recording

The system initiates an authorization request to a user via an application programming interface (API) provided by each of the plurality of resource exchange platforms. Upon obtaining valid authorization from the user, the system establishes a unique mapping relationship between an identifier of the user and an identifier of a corresponding resource account, and persistently stores the mapping relationship in an internal database of the system, thereby achieving association and binding among multiple users and multiple resource accounts across the plurality of resource exchange platforms. Upon initial establishment of the mapping relationship, the system acquires, via the corresponding API, an initial holding amount of a resource in each resource account, and sets the initial holding amount as the resource information of the user, and synchronously stores the resource information in the internal database. The resource information serves as baseline data for subsequent calculation of actual resource holding variation. For example, a user James opens one resource account on a resource exchange platform bitFlyer and deposits resources in an amount of 1,000,000 Japanese yen (JPY). After obtaining authorization from James via the API of bitFlyer, the system establishes a mapping relationship between an identifier of James and an identifier of the resource account, acquires an initial holding amount of 1,000,000 JPY of the resource account, and stores the initial holding amount as resource information of James.

### System permission acquisition and restriction

After establishing the mapping relationship and recording resource information, the system obtains, via the APIs of the plurality of resource exchange platforms, only read-only query permission and resource allocation execution permission of each resource account of each user, without obtaining resource withdrawal permission. The system further does not obtain any resource custody or resource transfer permission, thereby ensuring that the system operates as a non-custodial system that does not control or interfere with actual resource holding states of users on resource exchange platforms, and complies with regulatory requirements for cross-platform resource transactions.

This step enables full-domain association among multiple users, multiple resource exchange platforms, and multiple resource accounts, thereby overcoming limitations of resource management confined to a single platform or a single account and providing a foundation for subsequent cross-platform unified resource allocation and entitlement calculation. Meanwhile, strict permission restriction ensures independence and security of user resources and avoids compliance and security risks associated with resource custody.

Step II: Creating, for each user, an internal resource record carrier configured to store an entitlement value associated with the user expressed in a common virtual metering unit.

Step II corresponds to an internal metering carrier creation stage of the system and is executed by the entitlement calculation module of the system. For each user for whom resource account binding has been completed, the system is configured to create a corresponding internal resource record carrier and to perform unified measurement of resource information of different resource types based on the common virtual metering unit. Step II includes the following operations.

### Creation and initialization of the internal resource record carrier

The system creates, in the internal database of the system, an independent internal resource record carrier for each user, and the internal resource record carrier is uniquely associated with the identifier of the user, thereby ensuring that entitlement measurement of each user is independent and non-interfering. The system initializes an entitlement value in the internal resource record carrier to zero. That is, at an initial state, the internal resource record carrier has a value of zero in the common virtual metering unit, and subsequent values are adjusted only through entitlement balancing operations.

### Configuration of the common virtual metering unit and conversion rules

The internal resource record carrier is measured using the common virtual metering unit defined within the system. The common virtual metering unit is a system-specific accounting unit, and a value thereof is associated with one or more reference resource types according to a preset conversion rate. The reference resource types may include stablecoins (e.g., Tether (USDT) and USD Coin (USDC)) and fiat currencies (e.g., United States Dollar (USD)). For example, one common virtual metering unit may be set to be equivalent to 1 USDT.

The preset conversion rate may be pre-stored in a configuration file of the system and can be dynamically updated. The system further includes a conversion-rate calculator configured to dynamically generate the preset conversion rate based on at least one of the following factors:
(1) a real-time exchange rate obtained from a market exchange rate data source, such as a real-time exchange rate between Japanese yen and U.S. dollars, and a real-time exchange rate between Korean won and U.S. dollars;
(2) a resource scarcity index indicating a market scarcity level of different resource types;
(3) a time decay factor indicating variation of resource value over time; and
(4) a user-level weighting coefficient defined based on a user level.

Through dynamic calculation by the conversion-rate calculator, the association between the common virtual metering unit and the reference resource types is maintained in alignment with actual market conditions, thereby ensuring accuracy of unified measurement.

By creating the internal resource record carrier and introducing the common virtual metering unit, step II resolves inconsistencies in measurement schemes among different resource exchange platforms and different resource types, thereby achieving unified measurement of cross-platform and cross-type resource entitlements. This provides a standardized calculation basis for subsequent aggregation of returns and entitlement allocation, and avoids deviations caused by direct calculation across multiple resource types.

Step III: Generating, based on a unified strategy, a plurality of resource allocation instructions for resource accounts of all of the plurality of users, to control each of the resource accounts of all of the plurality of users to independently execute the corresponding resource allocation instruction, without performing any actual resource transfer between the resource accounts of all of the plurality of users.

Step III corresponds to a generation and execution stage of resource allocation instructions of the system and is executed by the unified strategy execution module of the system. The system is configured to perform standardized generation of resource allocation instructions across platforms based on the unified strategy and allow independent execution by each resource account. Step III includes the following two sub-steps: (i) generation of resource allocation instructions; and (ii) execution of resource allocation instructions.

### Generation of resource allocation instructions

The system generates resource allocation instructions for all bound resource accounts corresponding to users based on the unified strategy. The unified strategy is a programmable cross-platform resource allocation strategy. The system may select at least one of the following strategies to generate the resource allocation instructions.

### Cross-platform resource price-difference strategy

The system is configured to monitor, in real time, price differences of a same resource type across different resource exchange platforms, and generate resource allocation instructions for buying low and selling high based on the price differences, thereby achieving cross-platform arbitrage.

### Trend-following strategy

The system is configured to perform technical analysis on historical resource price data, extract technical indicators such as moving averages, Moving Average Convergence Divergence (MACD), and Relative Strength Index (RSI), determine price trends based on the indicators, and generate resource allocation instructions conforming to the price trends.

### Statistical arbitrage strategy

The system is configured to analyze price correlations and cointegration relationships among different resource types, identify arbitrage opportunities based on statistical patterns, and generate corresponding resource allocation instructions.

### Resource supply-and-demand balancing strategy

The system is configured to preset holding amount thresholds for resource accounts. When a holding amount of a resource account exceeds or falls below the preset holding amount threshold, the system generates resource allocation instructions to achieve supply-demand balance among resource accounts.

### Machine-learning-based prediction strategy

The system is configured to predict price trends of resources based on trained machine learning models (such as Long Short-Term Memory (LSTM) and Extreme Gradient Boosting (XGBoost)), and generate resource allocation instructions based on prediction results.

The unified strategy includes, but is not limited to, the above strategies. Based on output results of the unified strategy, the system is configured to generate a plurality of structured resource allocation instructions conforming to API specifications of each of the plurality of resource exchange platforms, thereby ensuring that the structured resource allocation instructions are recognizable and executable by corresponding resource exchange platforms. Each of the structured resource allocation instructions includes at least one of: an account identifier, a platform identifier, a resource type identifier, an allocation direction identifier (buy/sell), an allocation quantity value, an allocation price or price condition expression, an order type identifier (limit/market), an instruction validity timestamp, an execution priority identifier, and an associated strategy identifier. These fields cooperatively define specific requirements of resource allocation, thereby ensuring accuracy of instruction execution.

### Execution of resource allocation instructions

The system is configured to utilize the generated resource allocation instructions to cause each of the resource accounts of all of the plurality of users to independently execute the corresponding resource allocation instruction. Specifically, the system is configured to send the structured resource allocation instructions, via APIs of the plurality of resource exchange platforms, to servers of corresponding resource exchange platforms in the form of hypertext transfer protocol (HTTP) requests. Upon receiving the structured resource allocation instructions, the servers of the resource exchange platforms drive corresponding resource accounts to perform resource allocation operations. The servers further return response results of instruction execution to the system. The system receives the response results and performs corresponding operations based on the response results, including recording execution statuses of the instructions (success/failure/partial execution) and updating operation logs of the resource accounts.

Throughout execution of the resource allocation instructions, no resource transfer of any form occurs between resource accounts. Each resource account independently executes instructions and independently generates resource holding variations, thereby ensuring independence of resources in each resource account and avoiding risks caused by inter-account resource coupling.

Step III achieves standardization and intelligent processing of cross-platform resource allocation based on the unified strategy, ensuring that allocation operations of all resource accounts conform to a unified optimization logic. Meanwhile, by enabling independent execution of resource accounts and preventing resource transfer operations, the system ensures efficiency of cross-platform allocation while avoiding risk propagation between accounts, thereby satisfying compliance and operational requirements of multiple resource exchange platforms.

Step IV: Calculating an actual resource holding variation of the at least one resource account of each user, and calculating a rule-determined resource variation of the at least one resource account of each user according to a predetermined rule:

Step IV corresponds to an entitlement calculation stage of the system and is executed by the entitlement calculation module. The entitlement calculation stage includes three sub-steps: (i) calculation of actual resource holding variation; (ii) aggregation of a platform-wide cumulative resource result; and (iii) calculation of rule-determined resource variation. All calculations are performed based on the common virtual metering unit to ensure consistency and comparability of calculation results.

### Calculation of actual resource holding variation

The system performs calculation of actual resource holding variation according to a preset settlement period, which may be configured as daily, weekly, or real-time based on practical requirements. At an end of each preset settlement period, the system acquires, via the corresponding API of the plurality of resource exchange platforms, a current resource holding amount of each resource account of all of the resource accounts on the plurality of resource exchange platforms. For each resource account of each user, the system calculates a difference between the current resource holding amount and a holding amount at an end of a previous settlement period to obtain the actual resource holding variation during the preset settlement period. The actual resource holding variation is determined according to the following expression: actual resource holding variation = resource holding amount at an end of a settlement period − resource holding amount at a beginning of the settlement period. The actual resource holding variation includes all resource changes of the at least one resource account, including changes in asset quantities, changes in denominated balance, and realized profit and loss.

For example, for resource account A, if a holding amount at an end of the previous settlement period is 1000 USDT, and a holding amount at an end of the preset settlement period is 1100 USDT, then the actual resource holding variation of resource account A is +100 USDT; and for resource account B, if a holding amount at the end of the previous settlement period is 500 USDT and a holding amount at the end of the preset settlement period is 470 USDT, then an actual resource holding variation of resource account B is −30 USDT.

### Aggregation of platform-wide cumulative resource result

After completing calculation of an actual resource holding variation for each resource account, the system converts actual resource holding variations of various resource types of all of the resource accounts of all of the plurality of users into values in the common virtual metering unit according to current conversion rates, thereby achieving standardized measurement of various resource types using a unified metering unit. Subsequently, the system sums all of the values in the common virtual metering unit to obtain the platform-wide cumulative resource result, which serves as a total baseline value for subsequent calculation of the rule-determined resource variation of each user.

For example, if a converted actual resource holding variation of resource account A is +100 common virtual metering units, a converted actual resource holding variation of resource account B is −30 common virtual metering units, and a converted actual resource holding variation of resource account C is +50 common virtual metering units, then the platform-wide cumulative resource result is 100 − 30 + 50 = +120 common virtual metering units.

The common virtual metering unit does not necessarily need to be directly convertible into a monetary value. However, in certain embodiments, value realization of an entitlement value in the common virtual metering unit may be indirectly achieved through one or more mechanisms. For example, under an offset mechanism, the entitlement value in the common virtual metering unit may be used in a subsequent cycle to offset future gains or losses; under a strategy allocation adjustment mechanism, a user’s participation weight in subsequent resource allocation may be adjusted based on accumulated entitlement values in the common virtual metering unit, thereby indirectly affecting actual returns; and under a settlement mechanism, settlement may be triggered based on accumulated entitlement values in the common virtual metering unit, for example by adjusting a distribution of future returns.

### Calculation of rule-determined resource variation

The system is configured to calculate the rule-determined resource variation of each user based on the platform-wide cumulative resource result according to a predetermined rule. The rule-determined resource variation is measured in the common virtual metering unit. The system provides two predetermined rules, which may be used independently or in combination, as follows.

### Transaction volume proportion rule

According to this rule, the system first determines a total resource allocation amount of all resource accounts of each user during the preset settlement period, calculates a total resource allocation amount of all resource accounts of all users during the preset settlement period, and obtains the platform-wide cumulative resource result. The rule-determined resource variation of each user is then calculated according to the following expression: rule-determined resource variation (in common virtual metering unit) = platform-wide cumulative resource result × (total resource allocation amount of the user ÷ total resource allocation amount of all users). For example, if the platform-wide cumulative resource result is +120 common virtual metering units, a total resource allocation amount of user A is 500, and a total resource allocation amount of all users is 2000, then the rule-determined resource variation of user A is 120 × (500 ÷ 2000) = +30 common virtual metering units.

### Strategy contribution rule

According to this rule, the system is configured to obtain at least one factor relating to strategy contribution of the user during the preset settlement period, including a number of times the user performs the unified strategy during the preset settlement period, an average resource scale of the at least one resource accounts of the user during the preset settlement period, a risk exposure value of the at least one resource account of the user during the preset settlement period, a historical strategy execution success rate of the user, and a historical cumulative contribution of the user. The system performs a weighted summation of the at least one factor according to preset weights to obtain a strategy contribution coefficient of the user. The platform-wide cumulative resource result is then multiplied by the strategy contribution coefficient to obtain the rule-determined resource variation of the user. The rule-determined resource variation is determined according to the following expression: rule-determined resource variation (in common virtual metering unit) = platform-wide cumulative resource result × strategy contribution coefficient of the user. For example, if the platform-wide cumulative resource result is +120 common virtual metering units and the strategy contribution coefficient of user B is 0.2, then the rule-determined resource variation of user B is 120 × 0.2 = +24 common virtual metering units.

Step IV achieves separate accounting of “actual resource gains” and “entitled resource benefits” through precise calculation of actual resource holding variation and standardized calculation of rule-determined resource variation. This approach objectively reflects actual operation results of each resource account and enables fair entitlement allocation across users based on the predetermined rule, thereby providing an accurate calculation basis for subsequent entitlement balancing.

Step V: Adjusting, based on a difference between the rule-determined resource variation and the actual resource holding variation, the entitlement value of each user stored in the internal resource record carrier, without modifying an actual resource holding amount of each resource account of each user.

Step V corresponds to an entitlement balancing stage of the system and is executed by the entitlement balancing module. Step V constitutes a core step of the system. By adjusting the entitlement value of each user in the internal resource record carrier, a balance is achieved between entitled resource benefits and actual resource holding amounts of users, while no actual resource holding amount of any resource account is modified throughout the entire process. Step V includes the following operations.

### Calculation of resource adjustment value

For each user, the system obtains the rule-determined resource variation of the user during the preset settlement period, expressed in the common virtual metering unit, and the actual resource holding variation of all resource accounts of the user during the preset settlement period, expressed in the common virtual metering unit. The system then performs a subtraction operation to calculate a resource adjustment value of the user according to the following expression: resource adjustment value = rule-determined resource variation − actual resource holding variation. The resource adjustment value is measured in the common virtual metering unit, and a sign (i.e., positive or negative) of the resource adjustment value indicates a direction of entitlement balancing.

### Adjustment of the entitlement value in the internal resource record carrier

The system is configured to compare the calculated resource adjustment value with a preset threshold and update the internal database based on a comparison result. Specifically, in response to a determination that the resource adjustment value is greater than zero, the system is configured to increase the entitlement value in the internal resource record carrier by the resource adjustment value, indicating that entitled resource benefits of the user exceed the actual resource holding amounts; in response to a determination that the resource adjustment value is less than zero, the system is configured to decrease the entitlement value in the internal resource record carrier by an absolute value of the resource adjustment value, indicating that entitled resource benefits of the user are less than the actual resource holding amounts; and in response to a determination that the resource adjustment value is zero, the system does not adjust the entitlement value, indicating that entitled resource benefits of the user are consistent with the actual resource holding amounts.

For example, if a rule-determined resource variation of user C is +50 common virtual metering units and an actual resource holding variation of user C is +30 common virtual metering units, then a resource adjustment value of user C is +20, and thus the entitlement value in the internal resource record carrier of user C is increased by 20 common virtual metering units. If a rule-determined resource variation of user D is +20 common virtual metering units and an actual resource holding variation of user D is +35 common virtual metering units, then a resource adjustment value of user D is −15, and thus the entitlement value in the internal resource record carrier of user D is decreased by 15 common virtual metering units.

Throughout the adjustment process, the system only modifies the entitlement value in the internal resource record carrier and does not transmit any resource transfer instruction or modification instruction to any resource exchange platform, and does not modify any actual resource holding amount of any resource account. All adjustment operations are performed within an internal ledger of the system, thereby ensuring that actual resource states of users on resource exchange platforms remain unaffected.

Step V solves a core problem of inconsistency between entitled resource benefits and actual gains of users across platforms and multiple resource accounts by adjusting entitlement values in the internal resource record carriers, thereby achieving precise balancing of entitlements. Meanwhile, through a design of “internal adjustment without affecting actual account resources,” the system not only ensures fairness of entitlement allocation, but also maintains independence and security of user resources, which constitutes a core feature of the non-custodial entitlement calculation of the system.

Step VI: Storage, presentation, and query of total resource entitlement data.

After completing adjustment of the internal resource record carrier, the system further performs data storage, graphical presentation, and historical query operations, which are executed cooperatively by the data storage module and the user interaction module to achieve lifecycle management of entitlement data. Step VI includes the following operations.

### Storage of total resource entitlement data

The system is configured to store, in a distributed database or a blockchain distributed ledger, the adjusted entitlement value in the internal resource record carrier and the actual resource holding amount obtained from the corresponding resource exchange platform to form total resource entitlement data of the user at a current time point. The total resource entitlement data represents an aggregated entitlement of the user, including both actual resource holding amounts and internal adjusted entitlement values, thereby ensuring data security, immutability, and traceability.

### Graphical presentation of total resource entitlement data

The system is configured to generate and render, for each user, a graphical user interface based on the stored total resource entitlement data, and displays the stored total resource entitlement data in graphical form to improve readability. The total resource entitlement data includes an actual-resource-holding-amount line chart of each resource account corresponding to the user, a remaining resource variation bar chart of the internal resource record carrier of the user, and a historical record list of resource entitlement adjustments. Through the graphical user interface, users may visually monitor resource holding states and entitlement adjustment conditions.

### Historical query of total resource entitlement data

The system is configured to support historical query operations for entitlement data. Specifically, the system is configured to receive a historical entitlement query request submitted by the user via a front-end interface, the historical entitlement query request including a specified time point or a specified time range. In response to the historical entitlement query request, the system is configured to retrieve total resource entitlement data corresponding to the specified time point or the specified time range from the distributed database or blockchain distributed ledger, generate a visual report including at least one of a chart, a graph, or a tabular display based on the retrieved total resource entitlement data, and display the visual report to the front-end interface.

Step VII: System anomaly monitoring and processing.

To ensure stable operation of the system, the system further includes the anomaly monitoring module configured to perform real-time monitoring and processing of anomalies via an independent thread. Step VII includes the following operations.

### Initiation of anomaly monitoring thread and anomaly identification

The system is configured to initiate an independent anomaly monitoring thread, which is separated from a core computation thread to avoid interference with core operations. The anomaly monitoring thread monitors operational and data states of the system in real time and identifies at least one of the following anomalies: (1) a number of API connection failures with resource exchange platforms exceeding a preset threshold; (2) an abnormal fluctuation of a resource holding amount of any resource account exceeding a preset percentage; and (3) a resource entitlement calculation deviation exceeding a preset absolute threshold.

### Anomaly alert and system suspension

Upon detecting any of the above anomalies, the system is configured to trigger an alert mechanism to generate an alert log including an anomaly type and an anomaly parameter, and transmit alert information to an administrator terminal. Meanwhile, the system is configured to suspend generation and execution of subsequent resource allocation instructions until the anomaly is cleared and the administrator confirms that the system has returned to a normal state, after which generation and execution of resource allocation instructions are resumed, thereby avoiding losses caused by erroneous operations under anomalous conditions.

To more clearly illustrate the technical solution of the present disclosure, a specific embodiment of the system is provided below with reference to a specific application scenario.

### Application scenario

U.S. user A opens resource account A1 (denominated in USDC) on Coinbase, Japanese user B opens resource account B1 (denominated in JPY) on bitFlyer, and Korean user C opens resource account C1 (denominated in KRW) on Upbit. The three users A, B, and C each authorize the system to bind their respective resource accounts. The system defines 1 common virtual metering unit = 1 USDT, and the preset conversion rate is dynamically calculated by the conversion-rate calculator based on real-time exchange rates. A settlement period is set to be daily. The rule-determined resource variation is calculated based on the transaction volume proportion rule. Anomaly monitoring thresholds are set as follows: the number of the API connection failures ≥ 3, resource holding fluctuation ≥ 20%, and resource entitlement calculation deviation ≥ 5 common virtual metering units.

Implementation steps include the following operations.

### Account binding and permission acquisition

The system obtains authorizations from three users A, B, and C via APIs of Coinbase, bitFlyer, and Upbit, establishes mapping relationships between user identifiers and resource account identifiers, and acquires initial holding amounts of the respective resource accounts (A1: 1000 USDC; B1: 1,000,000 JPY; C1: 1,500,000 KRW) as their respective resource information. The system obtains only read-only query permission and resource allocation execution permission, without obtaining resource withdrawal permission.

### Creation of internal resource record carriers

The system creates, for each of users A, B, and C, a corresponding internal resource record carrier, with an initial entitlement value of zero. The common virtual metering unit is defined to be equivalent to USDT. A conversion-rate calculator dynamically calculates preset conversion rates based on real-time exchange rates (1 USDC = 1 USDT; 1 JPY = 0.0067 USDT; 1 KRW = 0.00075 USDT).

### Generation and execution of resource allocation instructions

The system generates structured resource allocation instructions based on a cross-platform resource price-difference strategy, and sends the structured resource allocation instructions to the respective resource exchange platforms via APIs in the form of HTTP requests. Each resource account independently executes the corresponding structured resource allocation instruction, wherein the execution does not involve any transfer of resources between different resource accounts.

### Entitlement calculation

By way of example, at an end of a daily settlement period, the system acquires, in parallel, current resource holding amounts of all resource accounts (A1: 1080 USDC; B1: 1,010,000 JPY; C1: 1,480,000 KRW). The system calculates actual resource holding variations and converts the actual resource holding variations into values in the common virtual metering unit (A1: +80; B1: +67; C1: −15), and sums the values to obtain a platform-wide cumulative resource result of: 80 + 67 − 15 = +132 common virtual metering units. The system further determines total resource allocation amounts (A: 200; B: 150; C: 150; total: 500), and calculates rule-determined resource variations as follows: A: 132 × 200 / 500 = +52.8; B: 132 × 150 / 500 = +39.6; and C: 132 × 150 / 500 = +39.6 (all expressed in common virtual metering units).

### Entitlement balancing

The system calculates a resource adjustment value for each user as follows: A: 52.8 − 80 = −27.2; B: 39.6 − 67 = −27.4; C: 39.6 − (−15) = +54.6. The system adjusts the internal resource record carriers accordingly (an entitlement value of user A is decreased by 27.2, an entitlement value of user B is decreased by 27.4, an entitlement value of user C is increased by 54.6), without directly modifying actual resource holdings by the system itself.

### Data storage and presentation

The system stores the adjusted entitlement values in the internal resource record carriers and the actual resource holding amounts of resource accounts into a blockchain distributed ledger, and generates a graphical user interface to display line charts of resource holdings and bar charts of internal carrier value variations.

### Anomaly monitoring

An anomaly monitoring thread operates throughout the process to perform monitoring. No API connection failure, abnormal resource fluctuation, or calculation deviation is detected, and the system operates normally.

Implementation effects are described as follows.

Resource accounts of the three users A, B, and C independently execute operations on respective resource exchange platforms, and actual resource holding amounts of the three users A, B, and C are not changed. By adjusting the entitlement values in the internal resource record carriers, the system achieves balancing between entitled benefits and actual gains, thereby solving entitlement accounting problems across platforms and multiple currencies. All operations are automatically executed without manual intervention, significantly improving efficiency and accuracy of entitlement calculation.

Alternative embodiments are described as follows.

The system for unified entitlement calculation of cross-platform distributed resources supports multiple alternative embodiments and may be flexibly configured according to application scenarios, and may include the following implementations.

### Extension of common virtual metering unit

The reference resource type of the common virtual metering unit may be adjusted as required, and may be defined based on different stablecoins, fiat currencies, or other digital assets, and supports combined conversion based on multiple reference resource types.

### Dynamic configuration of predetermined rules

The predetermined rules for calculating entitled resource benefits (including transaction volume proportion rule and strategy contribution rule) may be dynamically configured, including selection of rules, adjustment of weighting coefficients, and modification of contributing factors.

### Flexible configuration of settlement period

The preset settlement period may be configured as daily, weekly, monthly, or real-time settlement to meet different entitlement calculation frequency requirements.

### Extension of resource account types

The system may be extended to various types of resource accounts, such as futures accounts and derivatives accounts, thereby adapting to cross-platform resource allocation and unified entitlement calculation scenarios for spot, futures, and derivatives.

### Extension of anomaly monitoring rules

Anomaly types and anomaly thresholds for anomaly monitoring may be extended and adjusted as required, thereby introducing additional monitoring dimensions and enhancing system stability.

Through the above comprehensive technical solution, the system for unified entitlement calculation of cross-platform distributed resources according to the present disclosure realizes distributed unified entitlement calculation across multiple platforms, multiple users, multiple resource accounts, and multiple resource types. Compared with the prior art, the system provides the following significant advantageous effects.

### Non-custodial property with improved security of user resources

The system obtains only read-only query permission and resource allocation execution permission of resource accounts, without obtaining resource withdrawal permission, and does not control or interfere with the actual resource holding amount of users on the resource exchange platforms. All entitlement adjustments are performed within the system, thereby fundamentally ensuring the independence and security of user resources and complying with regulatory requirements for cross-platform resource transactions.

Cross-platform adaptability, reducing limitations associated with single-platform resource management:

The system enables association among multiple users and multiple resource accounts across multiple resource exchange platforms, supports cross-platform resource allocation and entitlement calculation for different platforms and different resource types, adapts to resource exchange platforms in different jurisdictions and regulatory environments, and overcomes the limitations of single-platform, single-account resource management in the prior art.

### Unified metering with accurate and unbiased calculation results

By creating the internal resource record carrier and introducing the common virtual metering unit, in combination with dynamically updated preset conversion rates, the system achieves standardized unified measurement of different resource types, resolves inconsistencies in metering across multiple currencies and resource types, and ensures that calculation results of the actual resource holding variation, the platform-wide cumulative resource result, and the rule-determined resource variation are accurate and comparable.

### Fair entitlement accounting with precise balancing mechanism

The system realizes separate accounting of the actual resource holding variation and the rule-determined resource variation, achieves fair cross-user entitlement allocation through predetermined rules such as transaction-volume proportion and strategy contribution, and further achieves precise balancing between entitled benefits and actual returns by adjusting the internal resource record carrier based on the difference therebetween, without adjusting users’ actual resources, thereby balancing fairness and security.

### Full-process automation with improved implementability in practical systems

All operations of the system—including account binding, internal carrier creation, instruction generation and execution, entitlement calculation, entitlement balancing, and data storage and visualization—are automatically executed without manual intervention. The system further supports anomaly monitoring, dynamic configuration, and multi-scenario extensibility, thereby adapting to practical application requirements of cross-platform resource transactions with high engineering feasibility and practicality.

### Comprehensive data management with strong traceability

The system stores total resource entitlement data in the distributed database or the blockchain distributed ledger, ensuring data security and immutability, and supports graphical visualization and historical query, thereby enabling full lifecycle management of entitlement data and improving readability and traceability.

The system of the present disclosure is not merely a financial allocation rule, but rather a non-custodial unified entitlement calculation solution for cross-platform distributed resources implemented based on computer technology. Through a modular architecture, standardized metering, automated execution, and internal balancing, the system addresses deficiencies in the prior art, including custodial risks, poor adaptability, inconsistent metering, and unfair accounting in cross-platform resource entitlement calculation, and provides an efficient, secure, and fair technical solution for entitlement management in cross-platform distributed resource transactions.

As can be seen from the above technical solutions, the system is configured to establish the at least one relationship between each user of the plurality of users and the at least one resource account on the plurality of resource exchange platforms and to record resource information of each resource account of the at least one resource account, where each of the at least one resource account has a different resource type from one another, thereby achieving association and adaptation among multiple users, multiple resource exchange platforms, and multiple resource accounts, overcoming limitations of resource entitlement accounting confined to a single platform or a single account, and adapting to distributed resource transaction scenarios involving multiple entities across platforms. The system is further configured to create, for each user, the internal resource record carrier configured to store the entitlement value associated with the user expressed in the common virtual metering unit, thereby achieving standardized and unified measurement of different resource types, solving problems of entitlement accounting caused by inconsistent measurement schemes among different resource types , and enabling more consistent and accurate cross-type resource entitlement calculation. The system is further configured to generate, based on the unified strategy, the plurality of resource allocation instructions for the resource accounts of all of the plurality of users, to control each of the resource accounts of all of the plurality of users to independently execute the corresponding resource allocation instruction, without performing any transfer of resources between different resource accounts, thereby achieving strategy consistency for cross-platform resource allocation, avoiding risks associated with actual resource transfer between resource accounts, and ensuring independence of resources in each resource account. The system is further configured to, after execution of the plurality of resource allocation instructions, calculate the actual resource holding variation of the at least one resource account of each user, and calculate the rule-determined resource variation of the at least one resource account of each user according to the predetermined rule, thereby achieving separate and precise accounting of actual resource changes and entitled resource benefits, and providing a clear quantitative basis for entitlement allocation. The system is further configured to adjust, based on the difference between the rule-determined resource variation and the actual resource holding variation, the entitlement value of each user stored in the internal resource record carrier, without modifying the actual resource holding amount of each resource account of each user, thereby achieving precise balancing of resource entitlements. The system of the present disclosure compensates for differences between entitled resource benefits and actual resource benefits of users by adjusting the internal resource record carrier, without modifying actual resource states of resource accounts on the resource exchange platforms, thereby enabling fair and reasonable unified accounting and balancing of user resource entitlements in cross-platform distributed resource transactions. Accordingly, automated, standardized, and independent unified calculation of entitlements for cross-platform distributed resources is achieved, significantly improving efficiency and accuracy of cross-platform resource entitlement accounting.

The system of the present disclosure may be a distributed resource computation system implemented based on a computer system. The operation of the system is implemented based on a hardware architecture including server devices, storage devices, network communication devices, and terminal devices, and data communication and coordinated processing among these devices are achieved through a network architecture. The server devices are configured to execute core algorithmic logic related to resource computation and entitlement balancing; the storage devices are configured to store resource account data and internal resource record carrier data; the network communication devices are configured to implement interface interactions with respective resource exchange platforms; and the terminal devices are configured to provide users with data presentation and operation entry points. The above hardware and network architecture collectively constitute the technical foundation supporting operation of the system, enabling automated unified calculation of cross-platform distributed resources.

It may be further noted that the internal resource record carrier, as a data structure within the system, may be a computer-readable data recording unit, which may be created, updated, and stored through program logic. The internal resource record carrier may be implemented, for example, as an account record field in a database, an internally defined entitlement unit (such as points or accounting units), a numerical record in an internal virtual ledger, or a digital credential. The internal resource record carrier may express user entitlements in a quantified manner using the common virtual metering unit, and support dynamic adjustment based on computation results, thereby forming an internal entitlement recording system independent of external resource accounts.

In an exemplary implementation, the internal resource record carrier may be expressed in the form of points. For example, user A initially invests 10,000 USDT and user B initially invests 5,000 USDT. At the end of a preset settlement period, the asset of user A increases to 10,800 USDT, corresponding to an actual resource holding variation of +800 USDT; and the asset of user B increases to 5,100 USDT, corresponding to an actual resource holding variation of +100 USDT. At this time, the platform-wide resources increase from 15,000 USDT to 15,900 USDT, corresponding to a platform-wide cumulative resource result of +900 USDT. Based on a predetermined rule for entitlement allocation (e.g., a uniform rate of return), the system calculates that the rule-determined resource variation of user A is +600 USDT and that of user B is +300 USDT. Further, by calculating a difference between the rule-determined resource variation and the actual resource holding variation for each user, the system adjusts the internal resource record carrier, i.e., decreasing 200 common virtual metering units for user A and increasing 200 common virtual metering units for user B, thereby achieving internal entitlement balancing.

From the above mechanism, it can be seen that the internal resource record carrier primarily functions to record a difference between the rule-determined resource variation and the actual resource holding variation of each user, and to adjust user entitlements internally based on the difference. Throughout the process, the system does not modify any balance of resource accounts on external resource exchange platforms, nor does it perform any resource transfer operation, thereby achieving unified accounting and balancing of cross-platform resource entitlements while maintaining unchanged actual resource states of all resource accounts. This design effectively avoids security risks and compliance issues associated with resource custody and transfers.

In some embodiments of the present disclosure, providing data support for subsequent resource allocation strategies includes the following implementations.

The system may record, for each user or account, the actual resource holding variation, the rule-determined resource variation, and an adjustment value of the internal resource record carrier (i.e., the difference). These data reflect the actual execution performance of the account and a degree of deviation from the overall system strategy, and such deviation serves as an important feedback signal for strategy optimization.

In subsequent strategy execution, the system may assign different weights to different accounts or users based on variations in the internal resource record carrier. For example, for accounts whose long-term actual returns exceed their rule-determined entitlements, the system may reduce their strategy allocation weight; and for accounts whose long-term actual returns fall below their rule-determined entitlements, the system may increase their strategy participation weight, thereby achieving more balanced resource allocation.

When certain accounts continuously exhibit significant negative differences (i.e., actual returns are substantially lower than rule-determined entitlements), the system may reduce the proportion of such accounts participating in high-risk strategies, adjust their resource allocation scope, or mark such accounts for risk.

### 4. For strategy parameter optimization

Variation trends of the internal resource record carrier may be used to optimize parameters such as trading frequency, resource allocation ratios, and strategy triggering thresholds, thereby achieving adaptive optimization of strategies.

In some embodiments of the present disclosure, unified management and scheduling of resources across multiple resource exchange platforms include the following implementations:

The system establishes connections with multiple resource exchange platforms through standardized interfaces (e.g., APIs), thereby enabling acquisition of resource account information, monitoring of resource states, and transmission of resource allocation instructions, where each platform corresponds to an independent interface adaptation module.

The system converts data of all resource accounts across platforms into a unified format and aggregates them into a consolidated dataset to form a unified resource view, including account identifiers, platform identifiers, resource types, and current resource holding amounts. This unified view provides a basis for subsequent scheduling.

Based on the unified strategy, the system performs computation on the unified resource view to generate resource allocation instructions, including specifying a target platform, a target account, and a resource operation (increase/decrease/convert).

The scheduling instructions are transmitted to corresponding accounts on respective platforms for execution. Execution modes include transaction operations (e.g., resource buy/sell), configuration adjustments, and resource usage allocation. Each platform executes independently, while being coordinated in a unified manner by the system.

### 5. State synchronization and closed-loop control

The system may continuously acquire execution results from each platform and updates the unified resource view, thereby achieving state synchronization, execution result feedback, and input for subsequent rounds of strategy computation, thus forming a closed-loop control system.

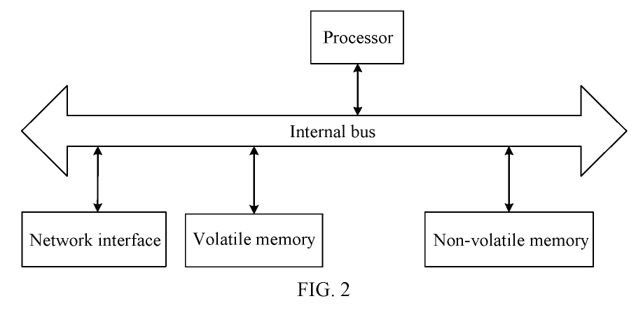

FIG. 2 is a schematic structural diagram of an electronic device according to embodiments of the present disclosure. At a hardware level, the electronic device includes a processor and optionally further includes an internal bus, a network interface, and a memory. The memory may include a volatile memory, such as a high-speed Random-Access Memory (RAM), and may also include a non-volatile memory, such as at least one disk storage device. The electronic device may further include other hardware required for specific applications.

The processor, the network interface, and the memory may be interconnected via an internal bus, which may be, for example, an ISA (Industry Standard Architecture) bus, a PCI (Peripheral Component Interconnect) bus, or an EISA (Extended Industry Standard Architecture) bus. The bus may be divided into an address bus, a data bus, a control bus, and the like. For ease of illustration, FIG. 2 shows only one bidirectional arrow, which does not indicate that there is only one bus or only one type of bus.

The memory is configured to store computer-executable instructions, specifically, computer programs that can be executed. The memory may include both volatile memory and non-volatile memory, and is configured to provide computer-executable instructions and data to the processor.

In one possible embodiment, the processor reads corresponding computer-executable instructions from the non-volatile memory into the memory and executes the instructions, or obtains corresponding computer-executable instructions from other devices, thereby implementing the system for unified entitlement calculation of cross-platform distributed resources. The processor executes the computer-executable instructions stored in the memory to implement operations of the system for unified entitlement calculation of cross-platform distributed resources provided in the embodiments of the present disclosure.

The operations of the system for unified entitlement calculation of cross-platform distributed resources provided in the foregoing embodiments may be applied in the processor or implemented by the processor. The processor may be an integrated circuit chip having signal processing capability. During implementation, the steps of the above method may be completed by integrated logic circuits of hardware in the processor or by instructions in the form of software. The processor may be a general-purpose processor, including a Central Processing Unit (CPU), a Network Processor (NP), or the like; or may be a Digital Signal Processor (DSP), an Application Specific Integrated Circuit (ASIC), a Field-Programmable Gate Array (FPGA), or other programmable logic devices, discrete gate or transistor logic devices, or discrete hardware components. The processor may implement or execute the methods, steps, and logical block diagrams disclosed in the embodiments of the present disclosure. The general-purpose processor may be a microprocessor or any conventional processor.

The steps of the method disclosed in the embodiments of the present disclosure may be directly embodied as execution by a hardware processor, or may be implemented by a combination of hardware and software modules in the decoding processor. The software modules may be located in mature storage media in the art, such as a Random-Access Memory (RAM), flash memory, a Read-Only Memory (ROM), a Programmable Read-Only Memory (PROM), an Electrically Erasable Programmable Read-Only Memory (EEPROM), or registers. The storage medium is located in the memory, and the processor reads information from the memory and, in combination with its hardware, completes the steps of the above method.

The embodiments of the present disclosure further provide a non-transitory computer-readable storage medium storing computer-executable instructions, which, when executed by one or more processors of an electronic device, cause the electronic device to perform the operations of the system for unified entitlement calculation of cross-platform distributed resources according to any of the embodiments of the present disclosure, and in particular to execute the above-described data query method.

The electronic device described in the foregoing embodiments may be a computer.

Those skilled in the art will appreciate that the embodiments of the present disclosure may be provided as a method or a computer program product. Accordingly, the present disclosure may take the form of an entirely hardware embodiment, an entirely software embodiment, or an embodiment combining software and hardware.

The embodiments of the present disclosure are described in a progressive manner, and identical or similar parts among the embodiments may be referred to each other. Each embodiment focuses on differences from other embodiments. In particular, for apparatus embodiments, since they are substantially similar to method embodiments, the description thereof is relatively concise, and reference may be made to the corresponding descriptions of the method embodiments.

It may further be noted that the terms “comprising,” “including,” or any other variations thereof are intended to cover a non-exclusive inclusion, such that a process, method, article, or device that includes a list of elements includes not only those elements but also other elements not expressly listed, or elements inherent to such process, method, article, or device. Without further limitation, an element defined by the phrase “comprising a …” or “including a …” does not exclude the presence of additional identical elements in the process, method, article, or device that includes the element.

The foregoing descriptions are merely embodiments of the present disclosure and are not intended to limit the present disclosure. For those skilled in the art, various modifications and variations may be made to the present disclosure. Any modifications, equivalent substitutions, improvements, and the like made within the spirit and principle of the present disclosure shall fall within the scope of the claims of the present disclosure.

What is claimed is:

1. A system for unified entitlement calculation of cross-platform distributed resources, comprising:
one or more processors; and
one or more memories storing computer-executable instructions which, when executed by the one or more processors, cause the system to:
establish at least one relationship between each user of a plurality of users and at least one resource account on a plurality of resource exchange platforms, and record resource information of each resource account of the at least one resource account, each of the at least one resource account having a different resource type from one another;
create, for each user, an internal resource record carrier of the system configured to store an entitlement value associated with the user expressed in a common virtual metering unit;
generate, based on a unified strategy, a plurality of resource allocation instructions for resource accounts of all of the plurality of users, to control each of the resource accounts of all of the plurality of users to independently execute the corresponding resource allocation instruction, without performing any actual resource transfer between the resource accounts of all of the plurality of users;
after execution of the plurality of resource allocation instructions, calculate an actual resource holding variation of the at least one resource account of each user, and calculate a rule-determined resource variation of the at least one resource account of each user according to a predetermined rule; and
adjust, based on a difference between the rule-determined resource variation and the actual resource holding variation, the entitlement value of each user stored in the internal resource record carrier, without modifying an actual resource holding amount of each resource account of each user.

2. The system of claim 1, wherein the system configured to establish the at least one relationship between each user of the plurality of users and the at least one resource account on the plurality of resource exchange platforms and to record the resource information of each resource account of the at least one resource account is configured to:
obtain an authorization of each user via a corresponding application programming interface (API) of a plurality of APIs provided by the plurality of resource exchange platforms to establish a mapping relationship between an identifier of the user and an identifier of the corresponding resource account of the user, and store the mapping relationship into an internal database of the system; and
upon establishment of the mapping relationship, acquire, via the corresponding API, an initial holding amount of a resource in each resource account of each user, and set the initial holding amount as the resource information of the resource account of the user.

3. The system of claim 1, wherein after establishing the at least one relationship between each user of the plurality of users and the at least one resource account on the plurality of resource exchange platforms and recording the resource information of each resource account of the at least one resource account, the system is further configured to:
obtain, for each resource account of each user, read-only query permission and resource allocation execution permission, without obtaining resource withdrawal permission.

4. The system of claim 1, wherein the system configured to create, for each user, the internal resource record carrier is configured to:
create, in the internal database of the system, the internal resource record carrier for each user, and initialize an entitlement value in the internal resource record carrier to zero, the internal resource record carrier for each user being independent of an internal resource record carrier for another one of the plurality of users and is associated with an identifier of that user.

5. The system of claim 4, wherein the entitlement value in the internal resource record carrier is measured in the common virtual metering unit defined within the system, the common virtual metering unit is operable to be converted into a metering unit of each of one or more reference resource types according to a preset conversion rate, and the preset conversion rate is stored in a configuration file of the system and is dynamically updatable.

6. The system of claim 5, wherein the preset conversion rate is dynamically generated by a conversion-rate calculator in the system based on at least one of:
a real-time exchange rate obtained from a market exchange rate data source;
a resource scarcity index;
a time decay factor; and
a user-level weighting coefficient.

7. The system of claim 1, wherein the unified strategy comprises at least one of:
a cross-platform resource price-difference strategy that is configured to generate the plurality of resource allocation instructions by monitoring and using price differences of a same resource type across various resource exchange platforms;
a trend-following strategy that is configured to generate the plurality of resource allocation instructions based on technical analysis indicators derived from historical resource price data;
a statistical arbitrage strategy that is configured to generate the plurality of resource allocation instructions based on correlations and cointegration relationships of resource prices;
a resource supply-and-demand balancing strategy that is configured to generate the plurality of resource allocation instructions based on holding amount thresholds of resource accounts; and
a machine-learning-based prediction strategy that is configured to generate the plurality of resource allocation instructions by predicting resource price trends using a trained machine learning model.

8. The system of claim 1, wherein the system configured to generate, based on the unified strategy, the plurality of resource allocation instructions for the resource accounts of all of the plurality of users is configured to:
generate a plurality of structured resource allocation instructions conforming to API specifications of each of the plurality of resource exchange platforms, each of the plurality of structured resource allocation instructions comprising at least one of: an account identifier, a platform identifier, a resource type identifier, an allocation direction identifier, an allocation quantity value, an allocation price or price condition expression, an order type identifier, an instruction validity timestamp, an execution priority identifier, and an associated strategy identifier.

9. The system of claim 1, wherein the system configured to control each of the resource accounts of all of the plurality of users to independently execute the corresponding resource allocation instruction, without performing any actual resource transfer between the resource accounts of all of the plurality of users is configured to:
send the plurality of resource allocation instructions to servers of the plurality of resource exchange platforms via APIs of the plurality of resource exchange platforms in a form of hypertext transfer protocol (HTTP) requests, receive response results from the servers, and perform corresponding operations based on the response results, without performing resource transfers between the resource accounts of all of the plurality of users.

10. The system of claim 1, wherein the system configured to calculate the actual resource holding variation of the at least one resource account of each user is configured to:
at an end of each preset settlement period, acquire a current resource holding amount of each resource account of all of the resource accounts on the plurality of resource exchange platforms via the corresponding API of the plurality of resource exchange platforms; and
for each resource account of each user, calculate a difference between the current resource holding amount and a holding amount at an end of a previous settlement period to obtain the actual resource holding variation during the preset settlement period.

11. The system of claim 10, wherein after obtaining the actual resource holding variation, the system is further configured to:
convert actual resource holding variations of various resource types of all of the resource accounts of all of the plurality of users into values in the common virtual metering unit according to current conversion rates; and
sum the values in the common virtual metering unit to obtain a platform-wide cumulative resource result.

12. The system of claim 1, wherein the system configured to calculate the rule-determined resource variation of the at least one resource account of each user according to the predetermined rule is configured to:
determine a total resource allocation amount of all of the at least one resource account of each user during a preset settlement period, calculate a total resource allocation amount of all of the resource accounts of all of the plurality of users during the preset settlement period, and obtain a platform-wide cumulative resource result; and
calculate the rule-determined resource variation of each user in the common virtual metering unit based on the platform-wide cumulative resource result, the total resource allocation amount of all of the at least one resource account of each user, and the total resource allocation amount of all of the resource accounts of all of the plurality of users;
wherein the rule-determined resource variation of all of the at least one resource account of each user equals the platform-wide cumulative resource result multiplied by a ratio of the total resource allocation amount of all of the at least one resource account of each user to the total resource allocation amount of all of the resource accounts of all of the plurality of users.

13. The system of claim 1, wherein the system configured to calculate the rule-determined resource variation of each user according to the predetermined rule is configured to:
obtain at least one factor selected from a group consisting of a number of times the user performs the unified strategy during a preset settlement period, an average resource scale of the at least one resource account of the user during the preset settlement period, a risk exposure value of the at least one resource account of the user during the preset settlement period, a historical strategy execution success rate of that user, and a historical cumulative contribution of the user;
perform a weighted summation of the at least one factor according to preset weights to obtain a strategy contribution coefficient of the user; and
multiply the platform-wide cumulative resource result by the strategy contribution coefficient to obtain the rule-determined resource variation of the user.

14. The system of claim 1, wherein the system configured to adjust, based on the difference between the rule-determined resource variation and the actual resource holding variation, the entitlement value of each user stored in the internal resource record carrier, without modifying the actual resource holding amount of each resource account of each user, is configured to:
for each user, convert the rule-determined resource variation of the user during a preset settlement period into a first value in a common virtual metering unit;
convert the actual resource holding variation of the user during the preset settlement period into a second value in the common virtual metering unit; and
subtract the second value from the first value to obtain a resource adjustment value.

15. The system of claim 14, wherein the system is further configured to:
compare the resource adjustment value with a preset threshold, and update the internal database based on a comparison result;
wherein in response to a determination that the resource adjustment value is greater than zero, the system is configured to increase the entitlement value in the internal resource record carrier by the resource adjustment value;
wherein in response to a determination that the resource adjustment value is less than zero, the system is configured to decrease the entitlement value in the internal resource record carrier by an absolute value of the resource adjustment value; and
wherein in response to a determination that the resource adjustment value equals zero, the system is configured not to adjust the entitlement value.

16. The system of claim 1, wherein the system is further configured to:
for each user, after adjusting the entitlement value of the user in the internal resource record carrier corresponding to the user, store the adjusted entitlement value in the internal resource record carrier and the actual resource holding amount obtained from the corresponding resource exchange platform into a distributed database or a blockchain distributed ledger to form total resource entitlement data of the user at a current time point.

17. The system of claim 16, wherein the system is further configured to:
for each user, generate and render a graphical user interface that is configured to display the total resource entitlement data in graphical form, wherein the total resource entitlement data comprises an actual-resource-holding-amount line chart of each resource account corresponding to the user, a remaining resource variation bar chart of the internal resource record carrier of the user, and a historical record list of resource entitlement adjustments.

18. The system of claim 1, wherein the system is further configured to:
receive a historical entitlement query request submitted by the user via a front-end interface, the historical entitlement query request comprising a specified time point or a specified time range;
retrieve total resource entitlement data corresponding to the specified time point or the specified time range in response to the historical entitlement query request; and
generate a visual report comprising at least one of a chart, a graph, or a tabular display based on the retrieved total resource entitlement data and display the visual report on the front-end interface.

19. The system of claim 1, wherein the system is further configured to:
initiate an independent anomaly monitoring thread to monitor anomalies in real time, the anomalies comprising at least one of:
a number of API connection failures with resource exchange platforms exceeding a preset threshold;
an abnormal fluctuation of a resource holding amount of any resource account exceeding a preset percentage; and
a resource entitlement calculation deviation exceeding a preset absolute threshold; and
upon detecting any of the anomalies, trigger an alert mechanism to generate an alert log comprising an anomaly type and an anomaly parameter, and suspend generation and execution of subsequent resource allocation instructions until the anomaly is cleared.

20. A non-transitory computer-readable storage medium storing computer-executable instructions which, when executed by one or more processors, cause the one or more processors to perform operations of the system according to claim 1.
